(19) United States
(12) Patent Application Publication
(10) Pub. No.: US 2014/0250780 A1
(43) Pub. Date: Sep. 11, 2014

(54) REMOVABLE SUPPORT SURFACE

(71) Applicants: Hyo-Sang Lee, Goyang-City (KR); Sang Cheol Kim, Hackensack, NJ (US)

(72) Inventors: Hyo-Sang Lee, Goyang-City (KR); Sang Cheol Kim, Hackensack, NJ (US)

(21) Appl. No.: 14/282,708

(22) Filed: May 20, 2014

Related U.S. Application Data
(63) Continuation-in-part of application No. 13/281,216, filed on Oct. 25, 2011.

(30) Foreign Application Priority Data
Oct. 27, 2010 (KR) 10-2010-0105063

(51) Int. Cl. D04B 21/10; A01C 1/04; D04B 1/22

(52) U.S. Cl. CPC D04B 21/10; D04B 1/22; A01C 1/044
USPC 47/56; 442/1; 28/159

(57) ABSTRACT

A removable support surface has knitted loops of yarn, and has piles extending from the knitted yarn to form an artificial turf, or to form a hybrid turf when combined with natural grass which grows between the knitted yarn. The piles may be hollow to retain liquid, and the dimensions of the yarn and the piles may be adjusted during fabrication. The removable support surface is fabricated by warp knitting, and the piles may be bent to have a crimped configuration. When used in a bunker with sand, the crimped configuration prevents sand from migrating. The removable support surface may also be placed on a seeded mat, on a dirt layer, or on existing natural grass. The removable support surface may be composed of biodegradable material.

### CROSS-REFERENCE TO RELATED APPLICATIONS

This application is a continuation-in-part of application Ser. No. 13/281,216, filed on Oct. 25, 2011, which is incorporated by reference in its entirety.

### BACKGROUND OF THE INVENTION

1. Field of the Invention

The present invention relates to a removable support surface, and in particular to a removable support surface used as an artificial grass turf, hybrid grass turf or a support base for retaining other materials such as sand.

2. Description of Prior Art

For years natural grass or turf surfaces were used for most outdoor sports. Natural turf surfaces are surfaces constructed with a grass grown in soil, or some other surface layer of material (e.g., sand, sand and organic mixes, etc.), that is constructed upon a suitable foundation. Natural turf surfaces are generally preferred for their comfort, feel, grip, and appearance.

However, under heavy use and/or poor weather conditions, natural turf surfaces deteriorate rapidly and maintenance is costly. Intense activity on the turf destroys the turf and the root system, leaving mud and/or dirt as the playing surface. Due to the needs of the sports programs, play usually continues until the season is over and the field can be re-established. During this time, prior to re-establishment, the surface is often pockmarked and unattractive, uneven, and possibly even hazardous to use. Further, these natural turf surfaces are not useable during the re-establishment period because any use would defeat the reestablishment of the natural grass.

Thus, synthetic turf surfaces have been used as an alternative to natural turf surfaces. Synthetic grass surfaces require less maintenance and withstand a more intensive use than natural turfs. Synthetic turf surfaces generally come in two varieties, i.e., non-sand filled and sand filled synthetic turf. Non-sand filled synthetic turf is a dense synthetic material that takes the appearance of grass blades and is mounted indoors or outdoors, usually upon an asphalt and cushion foundation. Sand filled synthetic turf is a synthetic material similar to the non-sand filled synthetic turf, but is generally less dense than non-sand filled turf, and is filled with silica sand. The sand filled synthetic turf is mounted outdoors only upon structures similar to those used for non-sand filled turf and sometimes on other foundations of crushed rock cushion materials (rubber particles) mixed therein. Both may be used in conjunction with subsurface drainage.

Although synthetic turf surfaces are more durable and easier to maintain than natural turf surfaces they are only moderately successful for sports and other uses for many reasons. The most notable of the disadvantages of the synthetic turf surfaces is the discomfort for sports use, particularly over heating in the direct sun, unnatural traction, and friction burns. Additionally, these surfaces are generally expensive to clean and have a life expectancy of 8-12 years. Still further, outdoor synthetic turf facilities remove vast areas from the ecosystem, reducing natural processes including ground water recharge, oxygen and carbon monoxide balance, temperature modulation, and dust filtration. Moreover, harmful chemicals from the synthetic turf are discharged into the atmosphere when water from the turf is evaporated.

Installation and de-installation of synthetic turf is also difficult, time consuming and expensive, and there are significant drainage issues. Until recently, conventional artificial turf tried to imitate natural grass by using a tufting and woven process to form a synthetic grass pile on the surface of the turf. The tufting process used to construct conventional synthetic turf involves implanting the synthetic grass pile into a fabric backing. To prevent the synthetic pile from falling out the backing is coated to improve pull-out strength which creates an impermeable backing. To resolve drainage issues, holes are perforated into the backing, but the drainage system is still very limited. The installation of conventional artificial turf typically utilizes an adhesive to attach the firm artificial turf surface to the ground. Base construction and preparation is also necessary for proper installation. The stiff backing requires a flat installation surface due to the inflexible nature of the turf's construction. For at least these reasons, a number of synthetic turf surfaces are being converted back to the natural turf surfaces.

More recently, a hybrid turf or combination turf has been developed to combine the advantages of both types of turf. However, hybrid turfs of the prior art have numerous problems and disadvantages. First, the backing used in the prior art hybrid turf is a flat woven material with very small apertures for retaining the synthetic grass piles. Thus, it is difficult for natural grass to grow therethrough. Second, the prior art hybrid turf is expensive and time consuming to manufacture and install. In one example, the hybrid turf is farm grown and then cut and shipped to the playing field for installation. In another example, the hybrid turf is installed on the playing field using heavy machinery to weave synthetic yarn onto the ground surface to form a backing for the synthetic turf. Third, application of the prior art hybrid turf is limited. For example, it cannot be install on top of already growing natural grass, and cannot be installed on non-flat surfaces.

### OBJECTS AND SUMMARY OF THE INVENTION

Therefore, the objects of the present invention is to at least solve the problems and disadvantages of the prior art described above. More specifically, the present invention provides an economical removable support surface for various applications that can be easily installed and de-installed. When used as a synthetic turf, the removable support surface can be easily installed on any type of surface including but not limited to flat, slope and uneven surfaces, fences, doors, etc. When used as a hybrid turf, the removable support surface can be installed on an unprepared surface as well as on existed natural grass, and provides room for growing a robust natural grass turf while having excellent drainage. When used on inclined surfaces as a support base for other materials such as sand, the removable support surface provides a stable bottom support so that sand does not migrate in wet conditions.

The following presents a simplified summary of some embodiments of the invention in order to provide a basic understanding of the invention. This summary is not an extensive overview of the invention. It is not intended to identify key/critical elements of the invention or to delineate the scope of the invention. Its sole purpose is to present some embodiments of the invention in a simplified form as a prelude to the more detailed description that is presented later.

In a first embodiment, the present invention includes a removable support surface includes a net backing formed by a plurality of connected loops of yarn knitted together, and a plurality of piles knitted into the net backing by warp knitting. The removable support surface also has the plurality of piles extending substantially perpendicular to the net backing. In an alternative embodiment, the removable support surface has at least one of the plurality of piles composed of a hollow tube. In other embodiments, the yarn of the removable support surface has a predetermined thickness. In another alternative embodiment, the removable support surface has at least a portion of the plurality of piles bent in a crimped configuration, and the crimped configuration of the plurality of piles substantially prevents sand from migrating when used as a support base.

The knitted loops of yarn of the removable support surface are spaced to allow natural grass to grow therethrough. In another embodiment, a mat is pre-seeded with natural grass seeds, and a porous fabric is positioned on the mat, allowing natural grass from the natural grass seeds to grow therethrough, with the net backing of the removable support surface being mounted to the porous fabric, with the knitted loops of yarn spaced to allow the natural grass from the natural grass seeds to grow therethrough. In an alternative embodiment, at least one of the mat and the porous fabric is composed of a biodegradable material, and in another alternative embodiment, at least one of the net backing and the plurality of piles is composed of a biodegradable material. In further alternative embodiments, a portion of the plurality of piles has a color different from the remainder of the plurality of piles.

In a second embodiment, the present invention includes a hybrid turf having natural grass, a net backing positioned apart from the natural grass with the net backing formed by a plurality of connected loops of yarn knitted together and spaced to allow the natural grass to grow therethrough, and a plurality of synthetic grass piles knitted into the net backing. In an alternative embodiment of the hybrid turf, at least one of the plurality of synthetic grass piles is composed of a hollow tube. In another alternative embodiment, the hybrid turf includes a mat pre-seeded with natural grass seeds from which the natural grass grows, and also includes a porous fabric positioned on the mat, allowing the natural grass from the natural grass seeds to grow therethrough, such that the net backing of the hybrid turf is mounted to the porous fabric, with the knitted loops of yarn spaced to allow the natural grass from the natural grass seeds to grow therethrough. In another embodiment, the hybrid turf has at least one of the net backing and the plurality of synthetic grass piles composed of a biodegradable material.

The present invention also includes a method including knitting a plurality of connected loops of yarn to form a net backing, wherein the knitted loops of yarn are spaced, and knitting a plurality of piles into the net backing to form a removable support surface. The method further includes positioning the removable support surface apart from a mat pre-seeded with natural grass seeds from which the natural grass grows. In an alternative embodiment, the method further includes bending at least a portion of the plurality of piles to have a crimped configuration. In another embodiment, the method further includes positioning the removable support surface on a lower surface and positioning sand on top of the removable support surface.

### BRIEF DESCRIPTION OF THE DRAWINGS

The foregoing summary, as well as the following detailed description of presently preferred embodiments of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown.

In the drawings:

FIG. 1 is a bottom plan view of the removable support surface of the present invention;

FIG. 2 is a rear side perspective view of the removable support surface of FIG. 1;

FIG. 3 is a front side perspective view of the removable support surface of FIG. 1;

FIG. 4 is an enlarged view of the removable support surface of FIG. 3;

FIG. 5 is an enlarged side plan view of the removable support surface of FIGS. 1-4 having hollow, crimped synthetic piles;

FIG. 6 is a rear plan view of the removable support surface of FIG. 1 with crimped synthetic piles;

FIG. 7 is a front plan view of the removable support surface of FIG. 6;

FIG. 8 is an enlarged side plan view of the removable support surface of FIGS. 6-7;

FIG. 9 is an extended side plan view of the removable support surface of FIG. 8;

FIG. 10 is a sectional view of the removable support surface of FIG. 9 positioned in a bunker;

FIG. 11 is a top side perspective view of assembly of the removable support surface of FIGS. 1-4 with a pre-seeded mat;

FIG. 12 is a top side perspective view of the completed assembly of FIG. 11;

FIG. 13 is a top side perspective view of an embodiment of a removable support surface with a biodegradable backing;

FIG. 14 is a top side perspective view of the removable support surface of FIGS. 1-4 installed on a ground surface with seeds planted thereto;

FIG. 15 is an alternative top side perspective view of the removable support surface of FIGS. 1-4 installed within the ground;

FIG. 16 is an alternative top side perspective view of a removable support surface of FIGS. 1-4 secured to the ground after grass seeds have germinated; and

FIG. 17 is an alternative top side perspective view of the removable support surface of FIG. 1-4 secured to an existing layer of natural grass.

To facilitate an understanding of the invention, identical reference numerals have been used, when appropriate, to designate the same or similar elements that are common to the figures. Further, unless stated otherwise, the features shown in the figures are not drawn to scale, but are shown for illustrative purposes only.

### DETAILED DESCRIPTION OF THE PREFERRED EMBODIMENTS

Certain terminology is used in the following description for convenience only and is not limiting. The article “a” is intended to include one or more items, and where only one item is intended the term “one” or similar language is used. Additionally, to assist in the description of the present invention, words such as top, bottom, upper, lower, front, rear, inner, outer, right and left are used to describe the accompanying figures. The terminology includes the words above specifically mentioned, derivatives thereof, and words of similar import.

The present invention includes a removable support surface, which optionally includes synthetic piles, for providing an artificial turf or for use as a support base for holding materials such as sand. Alternatively, the present invention includes a hybrid turf composed of the removable support surface and natural grass.

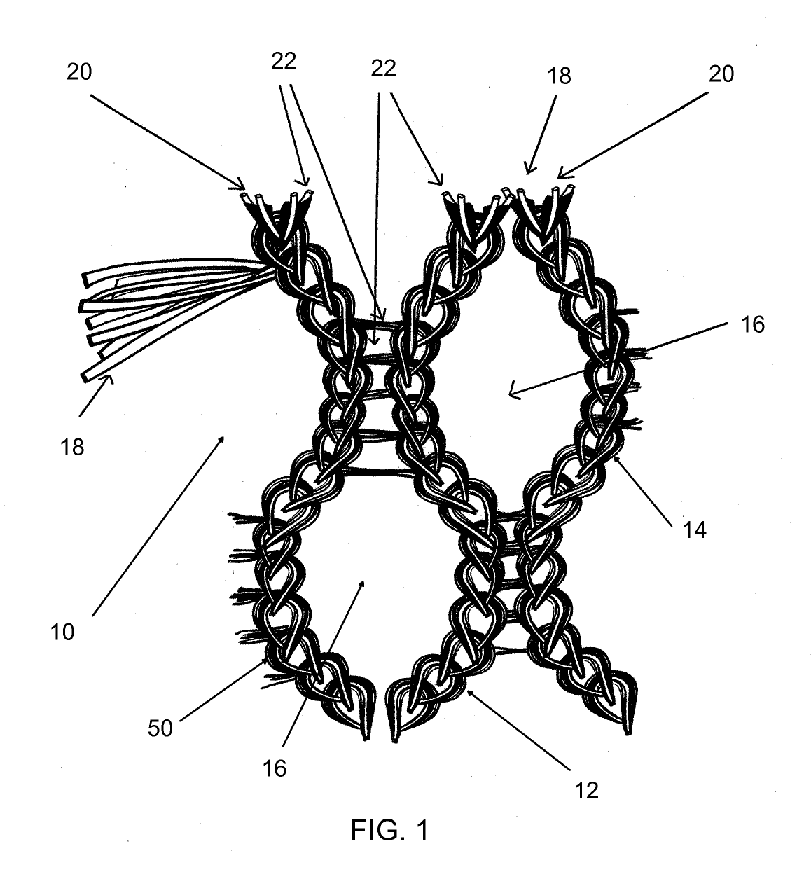

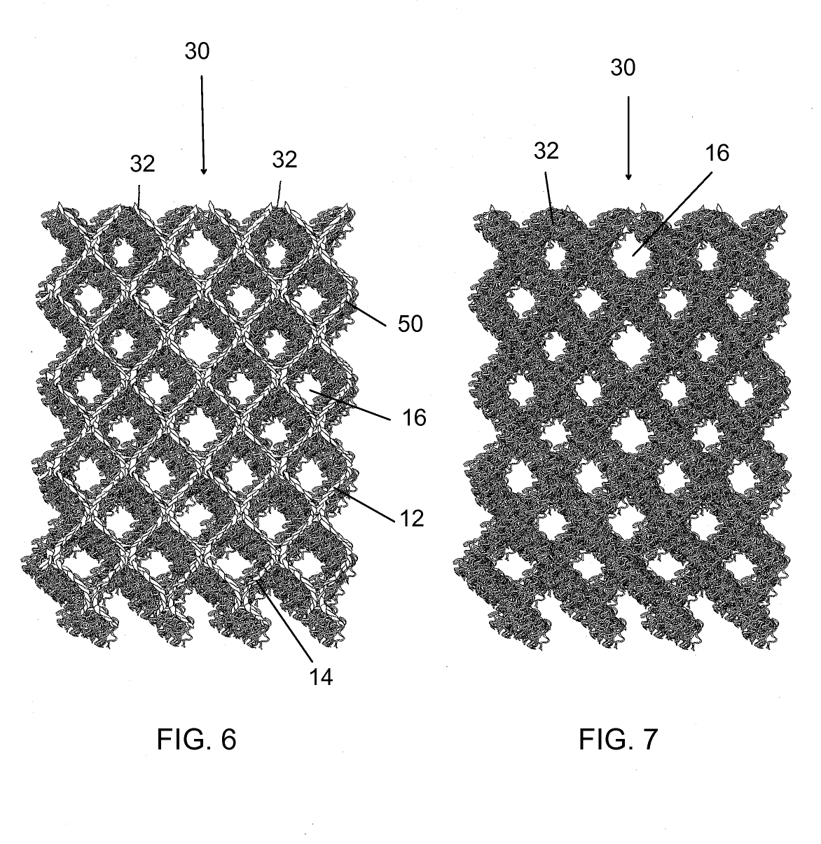

In a first embodiment, shown in FIGS. 1-9, the removable support surface 10 of the present invention includes a net backing 50 formed by a plurality of knitted loops of yarn 12, 14 connected together to form a plurality of empty spaces or holes 16 therein, and a plurality of piles 18 knitted into the net backing 50. As shown in FIG. 1, the plurality of knitted connected loops of yarn 12, 14 are formed by warp knitting, for example, using a Raschel knitting machine knitting together a warp yarn 20, a weft yarn 22, and synthetic grass pile yarn 18.

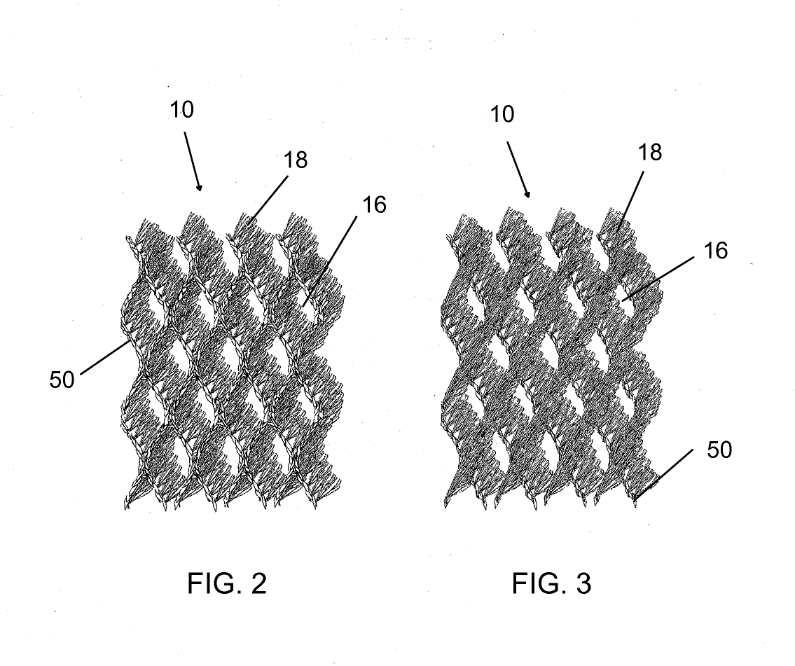

FIG. 2 is a rear side perspective view of the removable support surface 10 of FIG. 1; and FIG. 3 is a front side perspective view of the removable support surface 10 of FIG. 1. Using the Raschel knitting machine with customizable operating settings, the holes 16 of the net backing 50 form a generally honeycombed shape, and the size of the holes 16 can be adjusted, for example, from about ⅙ inch up to, for example, about 8 inches. Such a honeycomb shape increases the tear strength of the net backing 50, which allows the removable support surface 10 to be used on athletic fields as well as golf courses and in other high pedestrian traffic environments. By increasing the density of the net backing 50 to have a denser honeycomb shape, the durability of the removable support surface 10 is also increased. However, the backing 50 could take on other shapes, for example, diamonds, squares or rectangles.

In other embodiments, the yarn 20, 22 of the removable support surface 10 has a predetermined thickness. Referring to FIG. 1, the warp yarn 20 and the weft yarn 22 of the net backing 50 can be modified in thickness, for example, from 600 denier to 8000 denier or more, allowing for the fabrication of removable support surfaces 10 with reinforced net backings 50 to be stronger and less likely to rip, depending on the usage of the removable support surfaces 10.

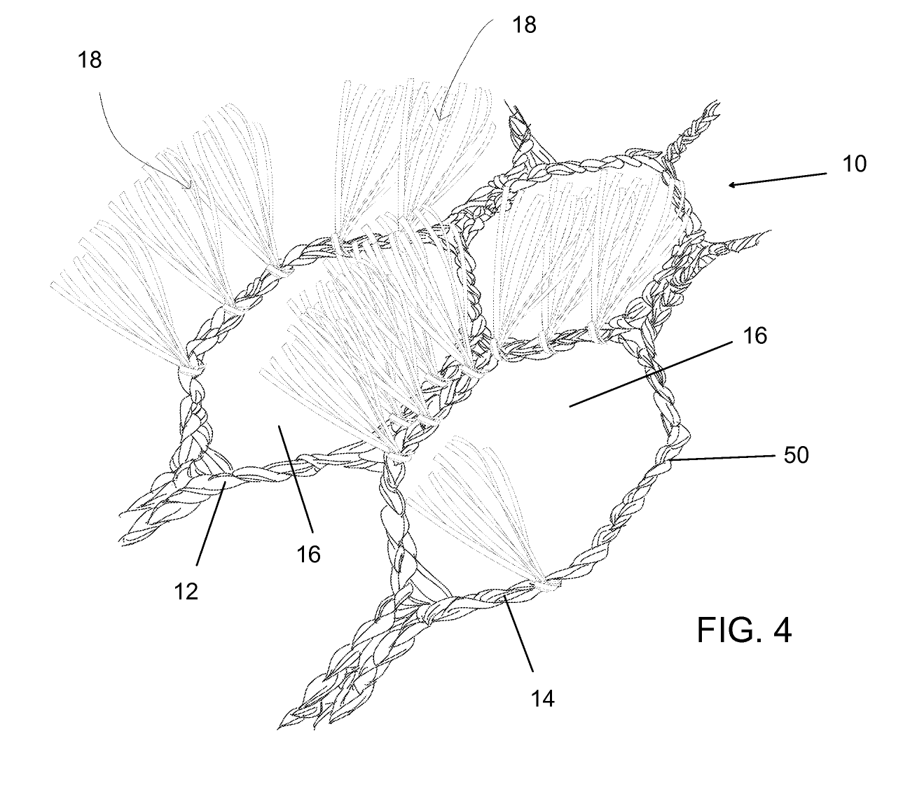

As shown in FIG. 4, the removable support surface 10 also has the plurality of piles 18 knitted into the knitted loops of yarn 14 to extend substantially perpendicular to the net backing 50, as shown in the enlarged view of the removable support surface 10. Due to the generally honeycombed shape of the backing 50, a pile 18 that is directly connected with the net backing 50 is enabled to stand substantially vertically.

Using the Raschel knitting machine with customizable operating settings to fabricate the removable support surface 10, the lengths and density of the synthetic grass piles 18 can also be adjusted. For example, the lengths of each of the synthetic grass piles 18 can be adjusted to range from about ⅓ inch up to about 4 inches, and any number of piles 18 could be knitted with the yarn 20, 22, but preferably 6 to 8.

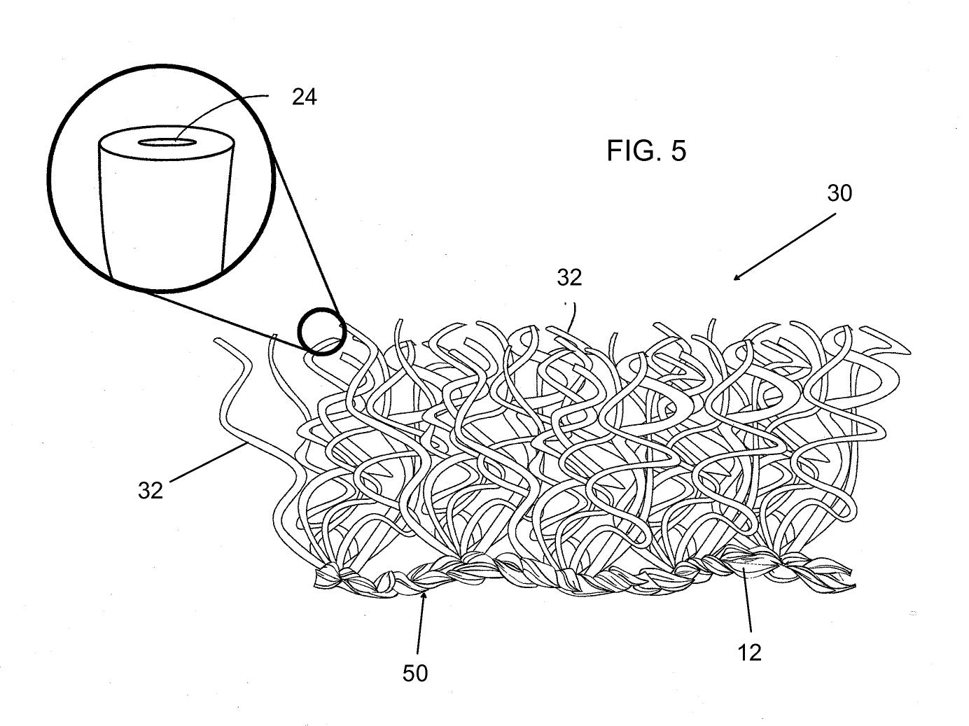

In an alternative embodiment, as shown in FIGS. 5-9, the removable support surface 30 has at least a portion of the plurality of piles 32 bent in a crimped configuration. The crimped piles 32 create a thicker and a more rigid configuration of the removable support surface 30, which protects any growing crown of natural grass interspersed within the spaces 16 of the removable support surface 30. For example, a one inch long synthetic pile, when crimped, can be reduced by 50% in length, to effectively be a 0.5 inch long pile but with a relatively larger thickness. By crimping the piles 32, the yarn tenacity of the removable support surface 30 of the present invention will be increased which then protects the underlying soil better than synthetic turfs of the prior art, which are matted down into the soil during ordinary use.

In another alternative embodiment, shown in FIG. 5, the removable support surface 30 has at least one of the plurality of piles 32 being composed of a hollow tube with an interior space 24, allowing for capillary action of a liquid, such as water from rain and/or from sprinklers to enter through the cavity of the hollow tube and therefore to be retained in at least one of such hollow piles 32. Such retained liquids then lowers, for example, the surface temperature of the synthetic grass piles 32, which prevents the exposed synthetic surface of the removable support surface 30 from getting burnt from direct sunlight, and which will also improve the health of any natural grass and other vegetation growing through the space 16 due to the retained moisture in the surrounding synthetic hollow piles 32, while also saving on water usage. The hollow tube configuration could also be used in straight piles 18 shown in FIGS. 1-4.

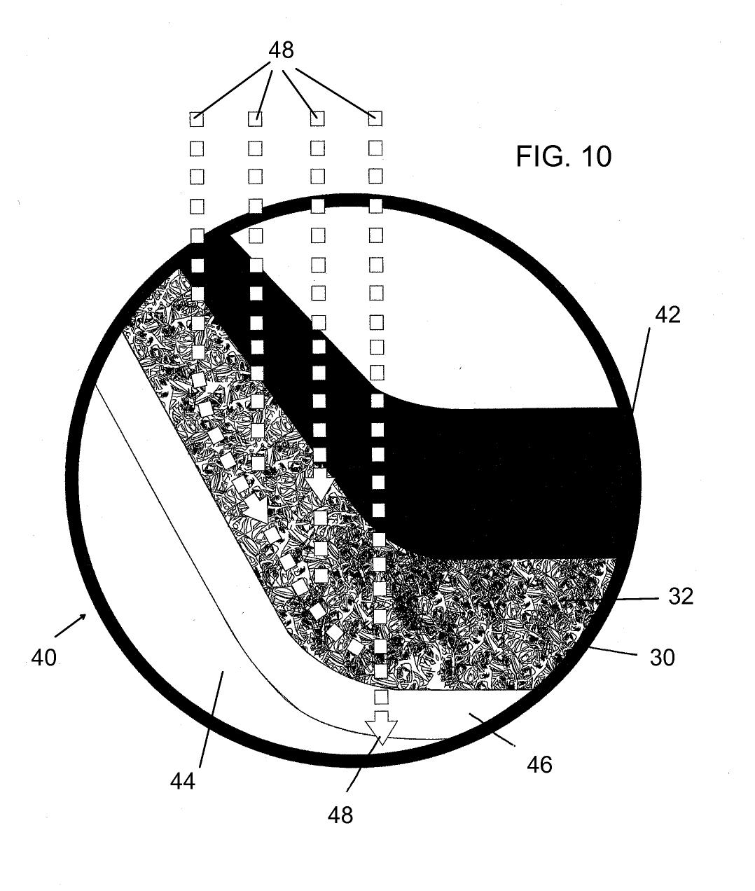

As shown in FIG. 10, the removable support surface 30 having the crimped configuration of the plurality of piles 32 is mounted in a bunker 40 having sand 42, such as on a golf course.

The removable support surface 30 rests on the underlying dirt 44 of the bunker, or alternatively on a bunker liner 46, for example, a permeable fabric such as geofabric, which is positioned on top of the dirt 44. As a liquid 48 such as rain water or water from sprinklers falls on the bunker, the liquid flows downward through the sand 42 and through the piles 32 of the removable support surface 30, providing improved drainage to eliminate the possibility of a top portion of the sand 42 from being top-heavy. Thus, the crimped configuration of the piles substantially prevents the sand 42 from migrating, and the crimped piles 32 will hold the sand 42 together even as such liquids 48 pass through the sand 42. Since the sand 42 does not migrate, the maintenance costs of the bunker are reduced and the amount of sand in the top layer of sand 42 is preserved. Furthermore, the bunker will have improved drainage and sand contamination of the underlying layers of the bunker 40, such as the bunker liner 46 and/or the dirt 44 below, is prevented. Unlike bunker liners of the prior art which lack a backing that secures the bunker liner, the removable support surface 30 of the present invention is capable of being secured to sloped surfaces to prevent sand 42 from migrating down the slope. For example, the honeycomb-shaped net backing of the removable support surface 30 of the present invention provides traction, allowing the removable support surface 30 to grip a steep sloped surface, for example, hills as well as sides of a bunker on a golf course, and provides stability to the base portion of the sand 42 to prevent migration.

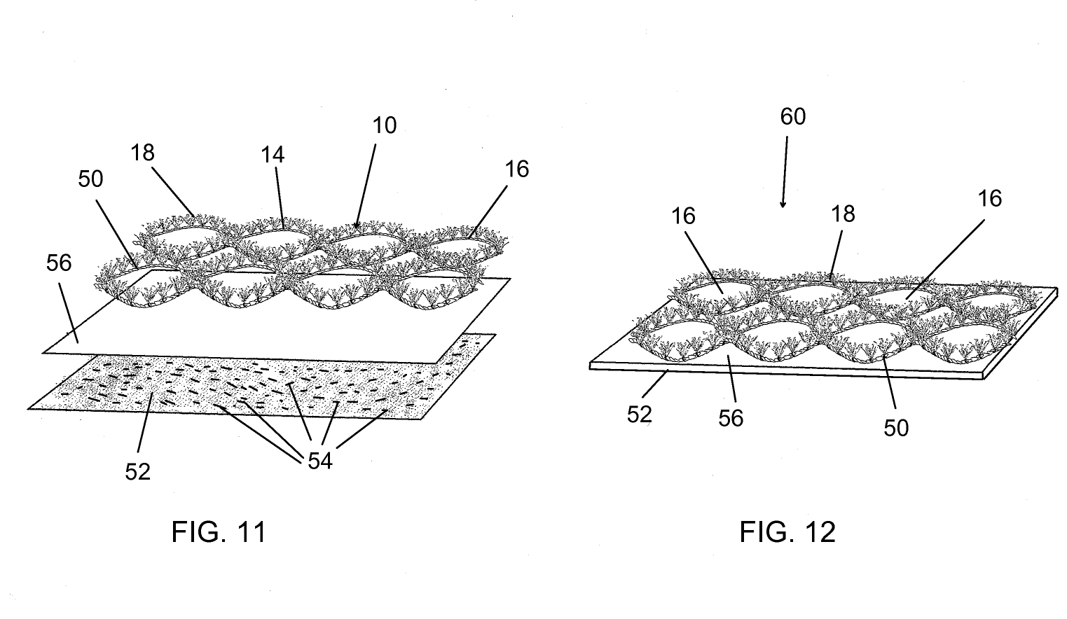

As shown in FIGS. 11-17, the plurality of knitted loops of yarn 14 of the removable support surface 10, which form a synthetic woven backing 50, are spaced to allow natural grass to grow therethrough. For example, in one embodiment shown in FIGS. 11-12, a mat 52 is pre-seeded with natural grass seeds 54, and a porous fabric 56 is positioned on the mat 52, as shown in FIG. 11, allowing natural grass from the natural grass seeds 54 to grow therethrough, with the net backing 50 of the removable support surface 10 being mounted to the porous fabric 56 to form the assembly 60 shown in FIG. 12, which is placed on the ground such as a dirt surface. It is preferred that the mat 52 and porous fabric 56 are permeable and non-woven. The plurality of knitted yarn loops 14 are spaced to allow the natural grass from the natural grass seeds 54 to grow therethrough. In an alternative embodiment of the assembly 60 of FIGS. 11-12, at least one of the mat 52 and the porous fabric 56 is composed of a biodegradable material, such as a polypropylene sheet blended with known additives which makes polyolefin polymers into oxo-biodegradable polymers. Other known biodegradable materials such as cotton, flax, hemp, sisal, burlap (also known as jute) could be used as well. Using known methods, the fabrication of the mat 52 and/or the porous fabric 56 may be adjusted such that the mat 52 and/or the porous fabric 56 will biodegrade over the duration of between six months and two years, with the duration being adjustable during such fabrication.

Therefore, by using a pre-seeded mat 52, the need for separately seeding the ground is eliminated, which simplifies the grass seeding process, and facilitates the ease of installing natural grass turf in conjunction with the removable support surface 10, since both the removable support surface 10 and the seeds 54 are installed simultaneously. The pre-seeded mat assembly 60 of FIGS. 11-12 is useful for erosion control and any landscaping purposes, for example, on inclined surfaces where seeds would otherwise be displaced, as well as any installation that requires seeding, especially if such seeding is to be performed relatively uniformly over a large area, such as an athletic field.

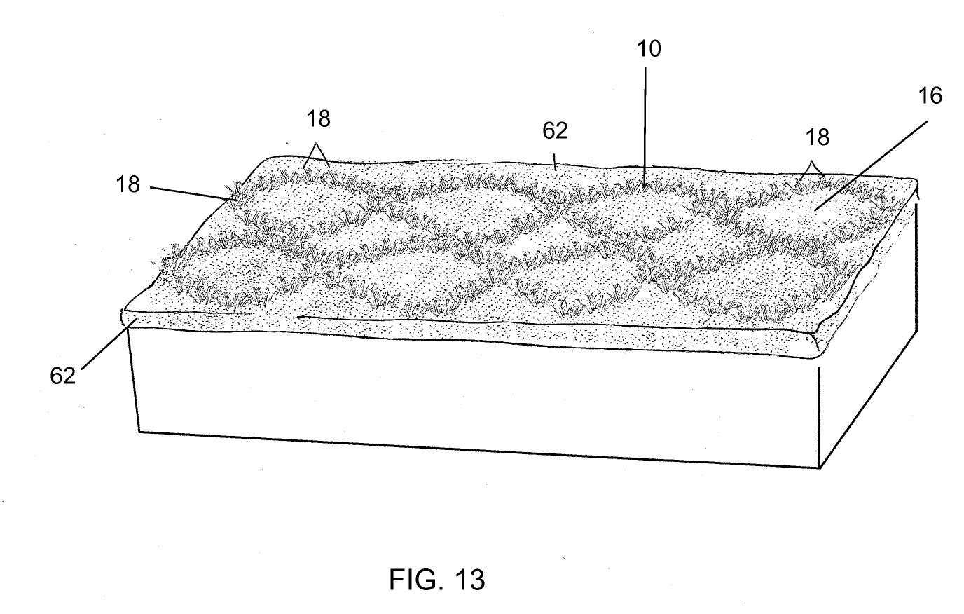

In another alternative embodiment, for the removable support surface 10, 30 of FIGS. 1-17, at least one of the net backing 50 and the plurality of piles 18 are composed of a biodegradable material. Using known methods, the fabrication of the net backing 50 and/or the piles 18 may be adjusted such that the net backing 50 and/or the piles 18 will biodegrade over the duration of between six months and two years, with the duration being adjustable during such fabrication. Therefore, after the biodegradation period, any natural grass growing within the spaces 16 of the removable and biodegradable support surfaces 10, 30 will have taken over, allowing the area for natural grass to naturally heal while maintaining the overall appearance of natural turf as the synthetic grass piles 18 biodegrade and disappear over time. FIG. 13 illustrates a ground surface wherein the backing 50 has biodegraded and blended in with dirt 62. Such a biodegradation process provides improved erosion control in areas subject to erosion. That is, the biodegraded backing 50 and/or the piles 18 remaining on or in the dirt 62 gives further support to the roots and crowns of the natural grass and provides additional pull strength. Any known biodegradable material can be used in the present invention, for example, such as those described above.

In further alternative embodiments, a portion of the plurality of piles 18 has a color different from the remainder of the plurality of piles 18, allowing multi-color assemblies of piles 18 to present multiple colors, for example to spell words on an athletic field such as team names. The multi-color assemblies of piles could also be used throughout the removable support surface 10, 30 to provide different shades of color to match the surroundings of where the removable support surface 10, 30 is installed.

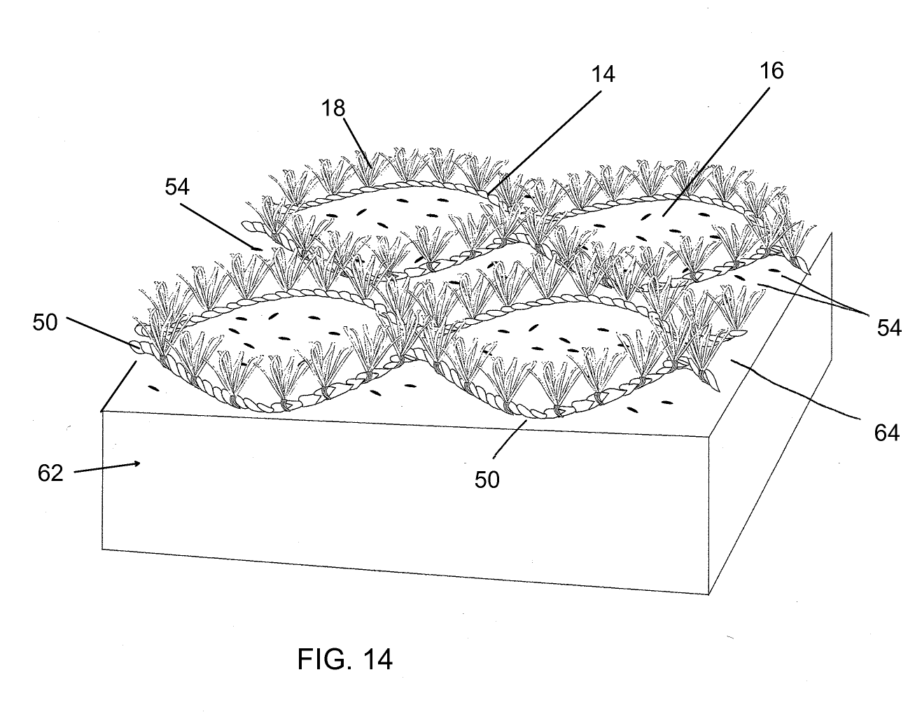

In a second embodiment shown in FIGS. 14-17, the present invention includes a hybrid turf on a ground surface 64 and/or natural grass 66 grown from seeds 54 which grow from the ground 62, a net backing 50 positioned apart from the natural grass, with the net backing 50 formed by a plurality of knitted yarn loops 14 spaced to allow the natural grass 66 to grow therethrough, and a plurality of synthetic grass piles 18 knitted into the net backing 50.

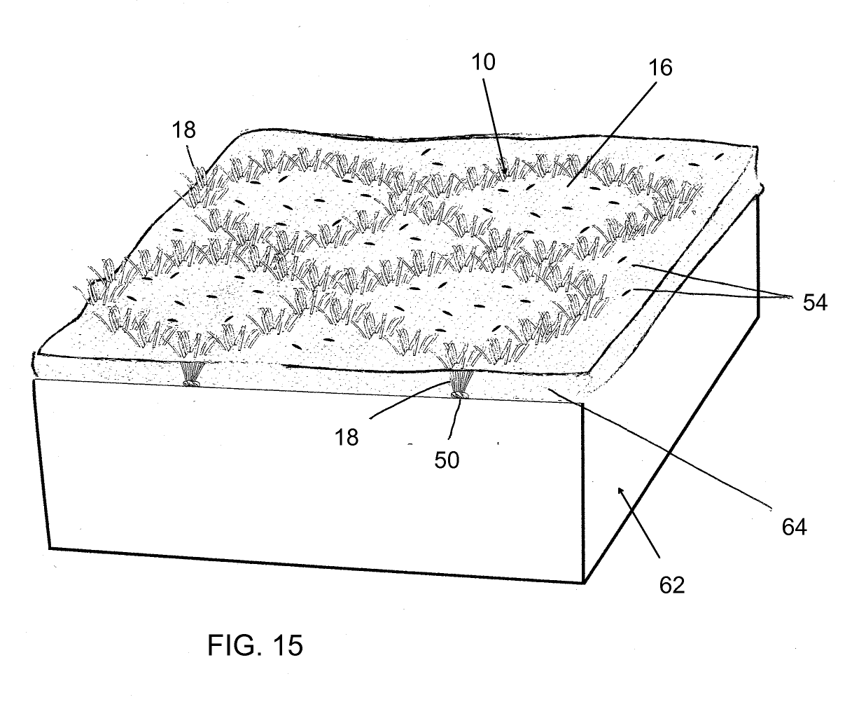

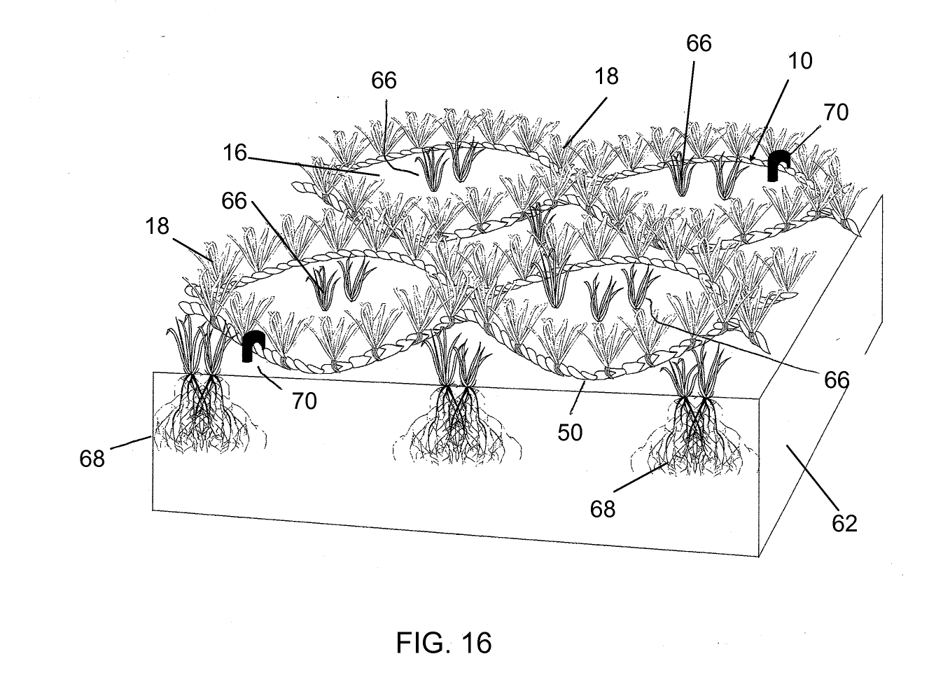

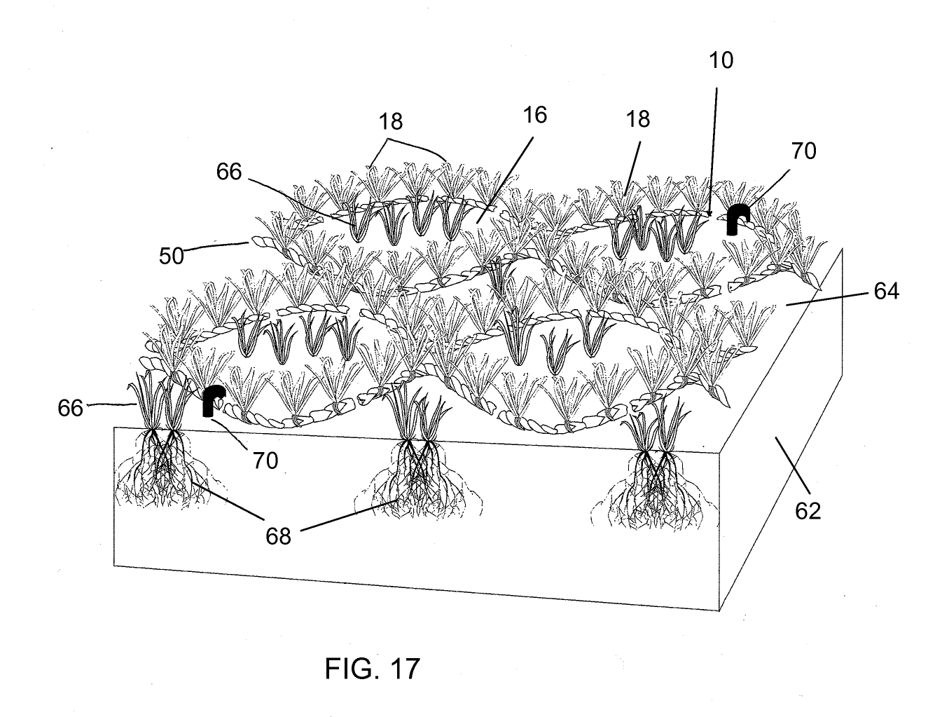

In one embodiment shown in FIG. 14, the net backing 50 lies on the ground surface 64, with the weight and frictional traction from the net backing 50 maintaining the net backing 50 in position on the ground 62. In another embodiment, as shown in FIG. 15, the net backing 50 is installed below the ground surface 64 within the ground 62, or alternatively dirt is poured on a positioned net backing 50 to bury the net backing 50 into the ground 62 formed by the poured dirt, which secures the net backing 50 in the ground 62 while the synthetic piles 18 extend from the ground surface 64. As the natural grass 66 grows from the seeds 54, as shown in FIG. 16, the grass roots 68 extend into the ground 62, with the tops or crowns of the natural grass 66 growing within the openings or spaces 16 of the net backing 50. Depending on the application of the removable support surface 10, 30, the net backing 50 could be installed on or within a ground surface 62 (FIGS. 14 and 15, respectively) without further securing the net backing 50. For example, if the application is purely decorative and no foot traffic is anticipated, the removable support surface 10, 30 could be installed as is. For applications such as a playing field or a golf course, or where heavy foot traffic is present, sod staples 70 or other fasteners, such as U-shaped anchor pins or nails, are used, as shown in FIG. 16, to secure the net backing 50 to the ground 62. Such sod staples 70 or other fasteners shown in FIGS. 16-17 may optionally also be composed of biodegradable material as described herein. In a further embodiment, shown in FIG. 17, the removable support surface 10 is laid on top of the natural grass 66 and/or the ground surface 64, and secured with fasteners 70.

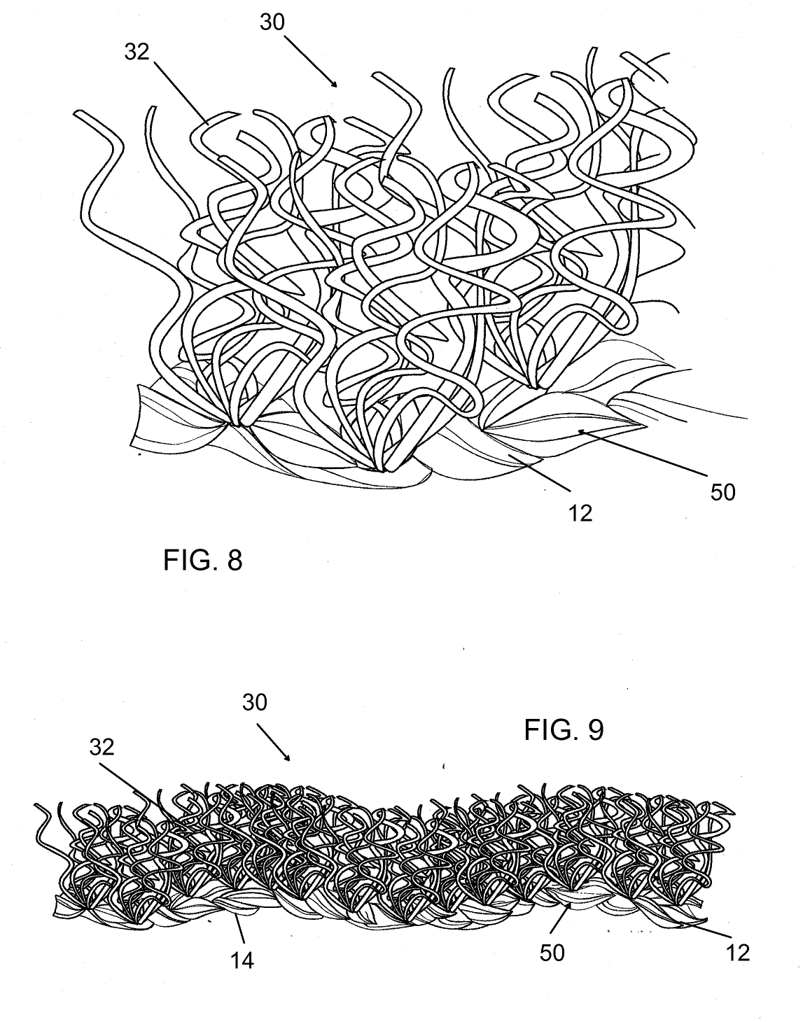

The present invention also includes a method comprising: knitting a plurality of connected loops of yarn 20, 22 to form a net backing 50, wherein the knitted yarn 14 is spaced, and knitting a plurality of piles 18 into the net backing 50 to form a removable support surface 10, as shown in FIG. 1. The knitting steps are performed, for example, by warp knitting using a Raschel knitting machine. The method further includes positioning the removable support surface 10 apart from a mat 52 pre-seeded with natural grass seeds 54, shown in FIGS. 11-12, from which the natural grass grows. In an alternative embodiment, the method further includes bending at least a portion of the plurality of piles 32 to have a crimped configuration, as shown in FIGS. 8-10. In another embodiment, the method further includes positioning the removable support surface 30 on a lower surface such as a dirt layer 44 and/or a fabric 46; and positioning sand 42 on top of the removable support surface 30 as shown in FIG. 10.

The present invention provides additional advantages, such as allowing the synthetic piles to be mowed with the natural grass for simple and routine maintenance. In addition, the removable support surfaces 10, 30 described herein may also be installed not only horizontally, but on curved surfaces such as mounds or hills, as well as vertically such as on walls or fences, for example, to mimic ivy vines, since the net backing may be composed of extremely flexible yarn material which can contour to almost any shape and surface. Moreover, the removable support surface could be sold at retail stores and/or shipped directly to customers because it could be packaged to fit on store shelves and/or conveniently shipped, and is easy to install.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A removable support surface comprising:
a net backing formed by a plurality of connected loops of yarn coupled together; and
a plurality of piles coupled into the net backing.

2. The removable support surface of claim 1, wherein the plurality of connected loops of yarn are coupled together by warp knitting.

3. The removable support surface of claim 1, wherein the plurality of piles extend substantially perpendicular to the net backing.

4. The removable support surface of claim 1, wherein at least one of the plurality of piles is composed of a hollow tube.

5. The removable support surface of claim 1, wherein the yarn has a predetermined thickness.

6. The removable support surface of claim 1, wherein at least a portion of the plurality of piles are bent in a crimped configuration.

7. The removable support surface of claim 6, wherein the crimped configuration of the plurality of piles substantially prevents sand from migrating.

8. The removable support surface of claim 1, wherein the coupled loops of yarn are spaced to allow natural grass to grow therethrough.

9. The removable support surface of claim 1, further comprising:
a mat pre-seeded with natural grass seeds; and
a porous fabric positioned on the mat, allowing natural grass from the natural grass seeds to grow therethrough;
wherein the net backing is mounted to the porous fabric, with the coupled loops of yarn spaced to allow the natural grass from the natural grass seeds to grow therethrough.

10. The removable support surface of claim 9, wherein at least one of the mat and the porous fabric is composed of a biodegradable material.

11. The removable support surface of claim 1, wherein at least one of the net backing and the plurality of piles is composed of a biodegradable material.

12. The removable support surface of claim 1, wherein a portion of the plurality of piles has a color different from the remainder of the plurality of piles.

13. A hybrid turf comprising:
natural grass;
a net backing positioned apart from the natural grass, with the net backing formed by a plurality of connected loops of yarn coupled together, a plurality of spaces formed between the coupled loops of yarn to allow the natural grass to grow therethrough; and
a plurality of synthetic grass piles coupled with the net backing.

14. The hybrid turf of claim 13, wherein at least one of the plurality of synthetic grass piles is composed of a hollow tube.

15. The hybrid turf of claim 13, further comprising:
a mat pre-seeded with natural grass seeds from which the natural grass grows; and
a porous fabric positioned on the mat, allowing the natural grass from the natural grass seeds to grow therethrough;
wherein the net backing is mounted to the porous fabric such that natural grass from the natural grass seeds to grow through the plurality of spaces.

16. The hybrid turf of claim 13, wherein at least one of the net backing and the plurality of synthetic grass piles is composed of a biodegradable material.

17. A method comprising:
knitting a plurality of connected loops of yarn to form a net backing, wherein the knitted loops of yarn are spaced; and
knitting a plurality of piles into the net backing to form a removable support surface.

18. The method of claim 17, further comprising:
positioning the removable support surface apart from a mat pre-seeded with natural grass seeds from which the natural grass grows.

19. The method of claim 17, further comprising:
bending at least a portion of the plurality of piles to have a crimped configuration.

20. The method of claim 17, further comprising:
positioning the removable support surface on a lower surface; and
positioning sand on top of the removable support surface.
